(19) United States
(12) Patent Application Publication
(10) Pub. No.: US 2014/0179153 A1
(43) Pub. Date: Jun. 26, 2014

(54) ADAPTER CORD MANAGEMENT ASSEMBLY

(71) Applicant: HEWLETT-PACKARD DEVELOPMENT COMPANY, L.P., Fort Collins, CO (US)

(72) Inventors: Britt C. Ashcraft, Tomball, TX (US); Eric Chen, Houston, TX (US)

(73) Assignee: Hewlett-Packard Development Company, L.P., Fort Collins, CO (US)

(21) Appl. No.: 13/721,535

(22) Filed: Dec. 20, 2012

(51) Int. Cl. H01R 43/00

(52) U.S. Cl. CPC H01R 43/00
USPC 439/501

(57) ABSTRACT

Embodiments of the present invention disclose an adapter cord management assembly. According to one embodiment, the cord management assembly includes a housing and cord attached to the housing on a first end, while a connector portion is formed on a second end of the cord opposite the first end. Moreover, the connector portion includes a first attachment feature configured to mate with a corresponding second attachment feature incorporated within the housing of the adapter.

### BACKGROUND

The emergence and popularity of mobile computing has made portable electronic devices—due to their compact design and light weight—a staple in today's marketplace. As these devices become further miniaturized, maintaining satisfactory battery power and life becomes a greater concern. The batteries of mobile devices, such as notebook computers, are generally powered via connection of a power adapter and cord coupled with an electrical power outlet. Generally, these power adapters include lengthy cords in order to allow for additional mobility by the operating user. However, when traveling with the portable device, both the bulky size of the power adapter and length of the associated cord combine to make the entire power assembly unwieldy and cumbersome during transport.

### BRIEF DESCRIPTION OF THE DRAWINGS

The features and advantages of the inventions as well as additional features and advantages thereof will be more clearly understood hereinafter as a result of a detailed description of particular embodiments of the invention when taken in conjunction with the following drawings in which:

FIG. 1 is a three-dimensional perspective view of the adapter cord management assembly according to an example of the present invention.

FIGS. 2A and 2B are front views of the adapter cord management assembly according to an example of the present invention.

FIGS. 3A-3C are side profile views of the adapter cord management assembly according to an example of the present invention.

### DETAILED DESCRIPTION OF THE INVENTION

The following discussion is directed to various embodiments. Although one or more of these embodiments may be discussed in detail, the embodiments disclosed should not be interpreted, or otherwise used, as limiting the scope of the disclosure, including the claims. In addition, one skilled in the art will understand that the following description has broad application, and the discussion of any embodiment is meant only to be an example of that embodiment, and not intended to intimate that the scope of the disclosure, including the claims, is limited to that embodiment. Furthermore, as used herein, the designators “A”, “B” and “N” particularly with respect to the reference numerals in the drawings, indicate that a number of the particular feature so designated can be included with examples of the present disclosure. The designators can represent the same or different numbers of the particular features.

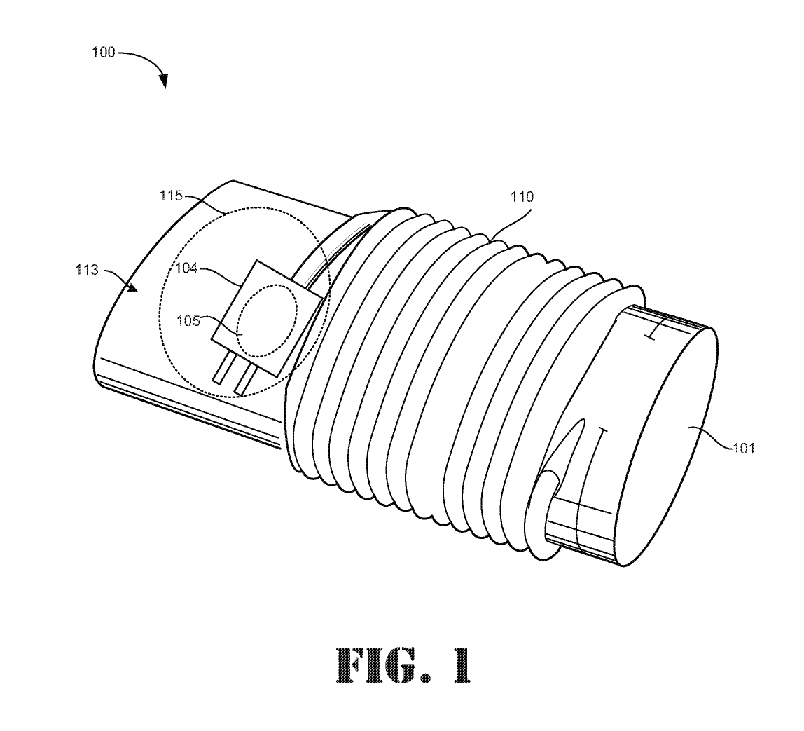

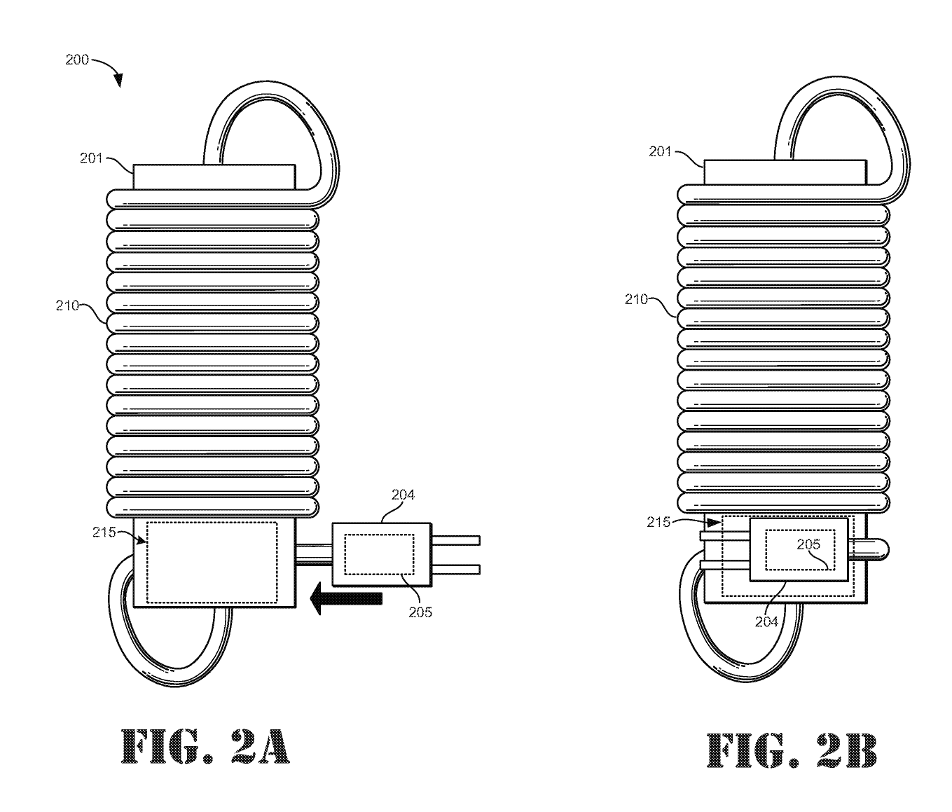

The figures herein follow a numbering convention in which the first digit or digits correspond to the drawing figure number and the remaining digits identify an element or component in the drawing. Similar elements or components between different figures may be identified by the user of similar digits. For example, 143 may reference element “43” in FIG. 1, and a similar element may be referenced as 243 in FIG. 2. Elements shown in the various figures herein can be added, exchanged, and/or eliminated so as to provide a number of additional examples of the present disclosure. In addition, the proportion and the relative scale of the elements provided in the figures are intended to illustrate the examples of the present disclosure, and should not be taken in a limiting sense.

Proper maintenance of adapter cords is often problematic for people on the go as lengthy cords are not always effectively secured and tend to get tangled. Prior solutions to the aforementioned problem include a hook and loop fastener(s) attached to an associated cord that wraps around the entire assembly. Even when using the hook and loop fastener, however, the power cord undesirably hangs away from the adapter housing and thus fails to provide a simple and clean management solution. Other solutions include geometric formation of a number fastening or grapple portions for wrapping the cord around the adapter. However, such a solution creates protruding elements that can become easily damaged and broken, thus rendering the solution ineffective.

Embodiments of the present invention disclose an adapter cord management assembly. According to one example, the power adapter management assembly includes magnetic features formed on the electrical plug and the adapter housing. The adapter cord may be wrapped around the housing and securely fixed to the housing by virtue of the plug connector being magnetically coupled to the adapter housing. As such, examples of the present invention provide an intuitive and clean design for effective cable management of a power adapter.

Referring now in more detail to the drawings in which like numerals identify corresponding parts throughout the views, FIG. 1 is a three-dimensional perspective view of the adapter cord management assembly according to an example of the present invention. As shown here, the assembly 100 includes an adapter housing 101 and an adapter cord 110 extending therefrom. The adapter cord 110 includes a connector plug formed on an end opposite the end that is attached to the adapter housing 101. According to one example, the adapter housing 101 and electrical plug 104 include magnetic features 115 and 105 respectively molded therein. In one instance, positioning of magnetic feature 115 within adapter housing 101 would correspond with a location of the electrical plug 105 upon the cord 110 being wrapped around the adapter housing 101 as shown in FIG. 1. However, the magnetic feature 115 may also be formed along an entire front surface area 113 to ensure that the electrical plug can be magnetically coupled with the adapter housing 101 along any position on said surface. Accordingly, the electrical plug 104 of the present example is configured to magnetically join to the adapter housing 101 so as to hold the cord 110 in a fixed position against the adapter housing 101.

FIGS. 2A and 2B are front views of the adapter cord management assembly according to an example of the present invention. As in the previous example embodiment, the adapter assembly 200 includes a housing 201, adapter cable 210, and a connector portion 204. The attachment feature 205 of the connector portion 204 may comprise of magnets formed therein and configured to couple with a corresponding attachment feature 215 formed within the adapter housing 201. As shown in FIG. 2A, the adapter cord 210 is wrapped tightly around the adapter housing 201. When the connector plug 204 is placed against the exposed surface (i.e., surface not covered by the wrapped adapter cord) of the adapter housing 201, magnetic forces from attachment features 205 and 215 cause the connector plug 204 to join the surface of the adapter housing along said exposed surface as shown in FIG. 2B.

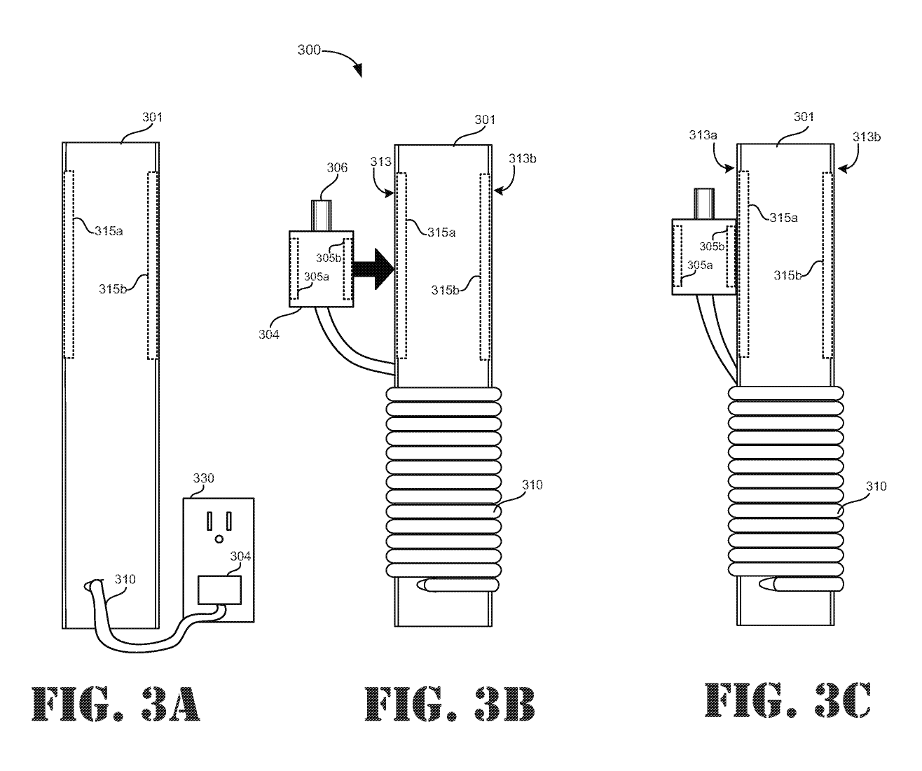

FIGS. 3A-3C are side profile views of the adapter cord management assembly according to an example of the present invention. FIG. 3A depicts the adapter management assembly in a non-transport state. As shown here, the adapter cord 310 is unwrapped with the connector portion 304 plugged into an electrical wall socket 330. Conversely, FIGS. 3B and 3C depict the adapter cord assembly 300 is in transport state in which the adapter cord 310 is wrapped around the adapter housing 301. According to one example embodiment, the connector plug 304 includes magnetic features 305a and 305b formed near opposite surface sides thereof. Similarly, the adapter housing 301 includes magnetic attachment features 315a and 315b formed along opposite contact surfaces 313a and 313b respectively of the adapter housing 301. However, examples of the present invention are not limited to this configuration as the attachment features may be formed around the entire periphery of the connector plug 304 and/or the adapter housing 310 rather than just the identified two surface sides depicted in FIGS. 3B and 3C. Moreover, as shown in FIG. 3B, in order to secure the cord in the wrapped position, a surface of the connector plug 304 is placed immediately adjacent to an exposed contact surface 313 (i.e., surface not covered by wrapped cord) of the adapter housing 301 so that the magnetic feature 305b magnetically couples with a corresponding magnetic feature 315a of the adapter housing 301.

Embodiments of the present invention provide an adapter cord management assembly. Moreover, many advantages are afforded by the cord management assembly according to embodiments of the present invention. For instance, since the present example incorporates the attachment means within the casing of the assembly, a user does not have to worry about losing or breaking any additional part(s) of the assembly. Moreover, the present solution serves to provide a simple and intuitive design that is easily operated and aesthetically pleasing to the user during transport of the computer and associated power cord assembly.

Furthermore, while the invention has been described with respect to exemplary embodiments, one skilled in the art will recognize that numerous modifications are possible. For example, although exemplary embodiments depict a magnet as the attachment mechanism, the invention is not limited thereto. For example, the attachment features may be a pressure-sensitive adhesive, latch, snap fastener, or any other attachment mechanism capable of easy attachment and detachment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement o order of elements or other features illustrated in the drawings or described herein need not be arranged in the particular way illustrated and described. Many other arrangements are possible according to some embodiments.

The techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the techniques.

What is claimed is:

1. An adapter cord management assembly comprising:
a housing;
a cord attached to the housing on a first end; and
a connector portion formed on a second end of the cord opposite the first end;
wherein a first attachment feature is incorporated within the connector portion and is configured to mate with a corresponding second attachment feature incorporated within the housing.

2. The assembly of claim 1, wherein the first attachment feature incorporated within the connector portion is magnetic.

3. The assembly of claim 2, wherein the second attachment feature incorporated within the housing is magnetic.

4. The assembly of claim 3, wherein the connector portion is configured to couple with the housing magnetically.

5. The assembly of claim 1, wherein when the cord is wrapped around the housing of the adapter, magnetic coupling of the connector portion with the housing serves to hold the cord securely around the housing.

6. The assembly of claim 1, wherein the second attachment feature is formed along at least two sides of the housing.

7. The assembly of claim 1, wherein the first attachment feature is formed on at least two sides of the connector portion.

8. The assembly of claim 1, wherein the second attachment feature is formed near an end of the housing opposite the attachment end of the cord and only near a surface area that is exposed when the cord is wrapped around the adapter.

9. An assembly for managing adapter cord utilized with a computing device, the assembly comprising:
an adapter casing including a power cable extending from the casing at a first end, wherein the power cable includes a plug formed on second end opposite the first end of the power cable;
a first attachment feature integrated within the plug;
a second attachment feature integrated with the adapter casing and configured to mate with the first attachment feature of the plug.

10. The assembly of claim 9, wherein the first attachment feature of the plug is a magnet.

11. The assembly of claim 10, wherein the second attachment feature of the adapter casing is a magnet.

12. The assembly of claim 11, wherein the plug is configured to magnetically couple with the adapter casing via the magnets.

13. The assembly of claim 11, wherein the second attachment feature is formed along at least two sides of the adapter casing.

14. The assembly of claim 13, wherein the first attachment feature is formed along at least two sides of the connector portion.

15. The assembly of claim 14, wherein the second attachment feature is formed near an end opposite the attachment end of the cord and only near a surface area that is exposed when the power cable is wrapped around the adapter casing.

16. An adapter cord management assembly comprising:
an adapter housing having a cord attached to the housing at a first end;
a plug connector formed on a second end of the cord opposite the first end attached to the adapter housing;
a first magnetic element incorporated within the plug connector;
a second magnetic element incorporated within the adapter housing and configured to magnetically couple with the first magnetic element of the plug connector.

17. The assembly of claim 16, wherein when the cord is wrapped around the adapter housing, magnetic coupling of the plug connector with the housing serves to hold the cord securely around the adapter housing.

18. The assembly of claim 17, wherein the second magnetic element is formed along at least two sides of the adapter housing.

19. The assembly of claim 18, wherein the first magnetic element is formed on at least two sides of the plug connector.

20. The assembly of claim 16, wherein the second magnetic feature is formed near an an end opposite the first end of the cord and only along a surface area that is exposed once the cord is wrapped around the adapter housing.
